(19) United States
(12) Patent Application Publication
(10) Pub. No.: US 2026/0365850 A1
(43) Pub. Date: Nov. 19, 2026

(54) ENCAPSULATION OF TPU GRANULES

(71) Applicant: BASF SE, Ludwigshafen am Rhein (DE)

(72) Inventor: Benjamin CHIKHI, Lemfoerde (DE)

(73) Assignee: BASF SE, Ludwigshafen am Rhein (DE)

(21) Appl. No.: 19/144,028

(22) PCT Filed: Dec. 28, 2023
(86) PCT No.: PCT/EP2023/087901

§ 371 Date: Jun. 27, 2025

(30) Foreign Application Priority Data
Dec. 29, 2022 (EP) 22217178.7

(51) Int. Cl. C08L 75/10

(52) U.S. Cl. CPC C08L 75/10

(57) ABSTRACT

The present invention is directed to particles comprising a composition (A) comprising a thermoplastic polyurethane (PU-A), and a composition (C-B) comprising a thermoplastic polyurethane (PU-B), wherein the composition (A) is at least partly covered with the composition (B), a process for preparing said particles as well as a process for producing an article using said particles.

The present invention is directed to thermoplastic polyurethane pellets, in particular pellets comprising a thermoplastic polyurethane based on aliphatic diisocyanate, at least partly coated by a second thermoplastic polyurethane. In particular, the present invention is directed to particles comprising a composition (A) comprising a thermoplastic polyurethane (PU-A), and a composition (B) comprising a thermoplastic polyurethane (PU-B), wherein the composition (A) is at least partly covered with the composition (B), a process for preparing said particles as well as a process for producing an article using said particles.

Thermoplastic polyurethanes usually are delivered in the form of pellets and is thus stored and distributed on the market well before being formed to articles finally used by customers.

During storage, delivery and the forming process the pellets are exposed to conditions that may adversely affect them. They may be negatively affected by radiation, by air, by water, by mechanical impact and the like. Depending on the properties of the thermoplastic polyurethane, pellets may also have the tendency to stick together during storage.

Therefore, it exists a long-lasting wish in the market, to prevent pellets from these adverse effects. Different approaches are undertaken to avoid negative input on the pellets. Appropriate packaging is required, which may be cost intensive and is a burden to the environment. Also additives are used to prevent the pellets from negative impact of the surrounding, which then often affect the properties of the thermoplastic polyurethane and also incur cost.

Surprisingly these problems were overcome by covering a thermoplastic polyurethane composition at least partly with a second polyurethane composition, for example covering the pellets obtained in the preparation process with a second polyurethane composition.

The encapsulation of materials is a “per se” known process. For example US 2018/0 222 087 A1 discloses the encapsulation of additives for easier handling in polymer preparation processes and US 2015/0 091 202 refers to improve the handling with pressure sensitive hot melt adhesives. This principle for decades was not recognized for solving the above mentioned problems regarding the handling of thermoplastic polyurethane pellets. Since particles such as pellets comprising a thermoplastic polyurethane are usually an intermediate product for melt processes encapsulating the material results in mixtures of different materials and thus changes the properties of the composition. It was therefore an object of the present invention to provide particles and processes for their preparation which avoid these problems.

According to the present invention, this problem is solved by a particle comprising a composition (A) comprising a thermoplastic polyurethane (PU-A), and a composition (B) comprising a thermoplastic polyurethane (PU-B), wherein the composition (A) is at least partly covered with the composition (B).

Thermoplastic polyurethane (PU-A) and (PU-B) are typically based on isocyanate, polyol, chain extender. These are also addressed as building components. Furthermore, additives or catalysts may be used in the preparation process. The properties of the thermoplastic polyurethanes may vary. The properties of the thermoplastic polyurethanes may for example depend on the building components used, additives used, and also the ratio of the components used.

In a first embodiment the invention is directed to a particle comprising a composition (A) comprising a thermoplastic polyurethane (PU-A), and a composition (B) comprising a thermoplastic polyurethane (PU-B), wherein the composition (A) is at least partly covered with the composition (B).

Polyurethane (PU-A) typically is prepared using a diisocyanate (I-A), a diol (D-A) and optionally a chain extender (CE-A). Polyurethane (PU-B) typically is prepared using a diisocyanate (I-B), a diol (D-B) and optionally a chain extender (CE-B).

It has been found that the properties of the particles according to the present invention are in particular advantageous when the thermoplastic polyurethane (PU-A) and (PU-B) are based on similar building components. For example the polyisocyanate (I-A) und (I-B) may be partly the same or identical or polyol (D-A) and (D-B) may be partly the same or identical or chain extender (CE-A) and (CE-B) may be partly the same or identical.

According to a further embodiment, the present invention is also directed to the particle as described above, wherein the thermoplastic polyurethane (PU-A) is the reaction product of the following building components:
a diisocyanate (I-A), a diol (D-A) and optionally a chain extender (CE-A);
and the thermoplastic polyurethane (PU-B) is the reaction product of the following building components: a diisocyanate (I-B), a diol (D-B) and optionally a chain extender (CE-B),
and at least one of the building components of the thermoplastic polyurethane (PU-A) and the thermoplastic polyurethane (PU-B) is at least partly the same,
more preferably the diol (D-A) and (D-B) and the diisocyanate (I-A) and (I-B) are at least partly the same, even more preferably, the diol (D-A) and (D-B), the diisocyanate (I-A) and (I-B), and
at least the chain extender (CE-A) and (CE-B) is at least partly the same.

According to a further embodiment, the present invention is also directed to the particle as described above, wherein the thermoplastic polyurethane (PU-A) is the reaction product of the following building components:
a diisocyanate (I-A), a diol (D-A) and optionally a chain extender (CE-A);
and the thermoplastic polyurethane (PU-B) is the reaction product of the following building components: a diisocyanate (I-B), a diol (D-B) and optionally a chain extender (CE-B),
and at least one of the building components of the thermoplastic polyurethane (PU-A) and the thermoplastic polyurethane (PU-B) is at least 50% identical, preferably at least 70% identical, more preferably at least 85% identical,
more preferably the diol (D-A) and (D-B) and the diisocyanate (I-A) and (I-B) are at least 50% identical, preferably at least 70% identical, more preferably at least 85% identical, even more preferably, the diol (D-A) and (D-B), the diisocyanate (I-A) and (I-B), and at least the chain extender (CE-A) and (CE-B) are at least 50% identical, preferably at least 70% identical, more preferably at least 85% identical.

In the context of the present invention, at least partially identical or the same means that the respective component used for the preparation of the thermoplastic polyurethane comprises at least to a given degree identical chemical structures.

To adjust the hardness of the thermoplastic polyurethanes it is possible to vary the amounts of the synthesis components used within relatively broad molar ratios, with the hardness customarily increasing as the amount of chain extender goes up. The mixing ratio of the components used is preferably adjusted so as to give a thermoplastic polyurethane having a Shore hardness in the range from 60A to 60D, determined as per DIN 53505, as for example in the range from 70A to 100A, determined as per DIN 53505, preferably having a Shore hardness in the range from 70A to 98A, determined as per DIN 53505, more preferably having a Shore hardness in the range from 70A to 90A, determined as per DIN 53505.

According to one further embodiment, therefore, the present invention relates to a composition as described above, wherein the thermoplastic polyurethane has a Shore hardness in the range from 60A to 100A, determined as per DIN 53505.

To produce the thermoplastic polyurethanes of the invention, the isocyanate composition and the polyol composition (PZ) are reacted in the presence of catalysts and optionally auxiliaries and/or adjuvants in amounts such that the equivalence ratio of NCO groups in the isocyanates to the sum total of the hydroxyl groups in the polyols used is 0.9 to 1.1:1, preferably 0.98 to 1.02:1, and more particularly approximately 0.99 to 1.01:1.

The particle preferably is part of a granulate comprising these particles. The particles may be rounded but also plate-like shaped. In a preferred embodiment the particles have a maximal extension of less than 30 mm, more preferable less than 20 mm and more preferably less than 10 mm. At the same time, the particle preferably has a minimum maximal diameter of 0.5 mm, preferably at least 1 mm, and more preferably of at least 2 mm.

The term composition indicates that the composition does not comprise the respective thermoplastic polyurethane only, but may comprise several thermoplastic polyurethanes, additives and/or auxiliaries.

According to the present invention composition (A) may comprise thermoplastic polyurethane (PU-A) in an amount of from 50 to 100% by weight, in particular in an amount in the range of from 60 to 98% by weight, more preferable in an amount in the range of from 70 to 90% by weight, in each case based on the weight of the composition. Composition B may comprise thermoplastic polyurethane (PU-B) in an amount of from 50 to 100% by weight, in particular in an amount in the range of from 60 to 98% by weight, more preferable in an amount in the range of from 70 to 90% by weight, in each case based on the weight of the composition.

According to the present invention, the composition (A) is at least partly covered with the composition (B). In particular, the surface of the particles comprising composition (A) or consisting of the composition (A) are at least partly covered with composition (B). According to the present invention, the degree of coverage depends on the properties of composition (A) and (B). In case composition (B) is for example used to shield composition (A) from radiation, the degree of coverage may be in the range of from 50 to 100% of the surface, in particular in the range of from 60 to 100% or also in the range of from 70 to 98%, 80 to 95% or 85 to 90%. In case composition (B) is for example used to avoid that particles prepared from composition (A) stick together, the degree of coverage may be in the range of from 40 or 50% to 100% of the surface, in particular in the range of from 60 to 100% or also in the range of from 70 to 98%, 80 to 95% or 85 to 90%.

According to the present invention, it is also possible that the composition (A), in particular, the surface of the particles comprising composition (A) or consisting of the composition (A) is completely covered by composition (B).

According to a further embodiment, the present invention is also directed to the particle as described above, wherein the composition (A) is completely covered by composition (B).

Composition (B) might be applied in a thin layer, for example as a film.

According to a further embodiment, the present invention is also directed to the particle as described above, wherein the composition (A) is covered with a film of composition (B) and the film of composition (B) preferably has a thickness of less than 1 mm, more preferably less than 0.5 mm, more preferably less than 0.1 mm.

It is particularly advantageous to apply the composition (B) in the preparation process of the particles comprising composition (A).

Preferably the thermoplastic polyurethane is prepared by reacting an organic isocyanate, preferably an diisocyanate, with a polyol, preferably having two functional groups reactive with isocyanate, also referred to as polyol diol, preferably having a number average molecular weight of from 0.5×10³ g/mol to 100×10³ g/mol and, if desired, a chain extender preferably having a molecular weight of from 0.05×10³ g/mol to 0.499×10³ g/mol, preferably in the presence of a catalyst, an auxiliary, an additive, or a mixture thereof.

The components organic isocyanate, preferably diisocyanate, polymer diol and chain extender are also addressed individually or together as building components. The building components including the catalyst and/or the auxiliary and/or the additive are also called input materials.

In order to adjust the hardness and melt index of the thermoplastic polyurethane (TPU), the molar ratios of the quantities of the building components (b) and chain extender (c), and optionally water, can be varied, whereby the hardness and melt viscosity increase with increasing content of isocyanate or with increasing content of isocyanate and chain extender (c), while the melt flow index decreases.

In order to prepare the polyisocyanate polyaddition product, preferably the thermoplastic polyurethane, the building components isocyanate, compound reactive with isocyanate, in a preferred embodiment also the chain extender, are reacted in preferred embodiments in the presence of a catalyst, and optionally auxiliaries and/or additives in such quantities that the equivalent ratio of NCO groups of the isocyanate, preferably the diisocyanate to the sum of the hydroxyl groups of the component reactive with isocyanate and chain extender is 0.95 to 1.10:1, preferably 0.98 to 1.08:1 and in particular approximately 1.0 to 1.05:1. In a very preferred embodiment the equivalent ratio is 1.0.

The polyisocyanate polyaddition product, preferably the thermoplastic polyurethane, preferably has a weight-average molecular weight of at least 0.1×10⁶ g/mol, preferably of at least 0.4×10⁶ g/mol and in particular of at least 0.6×10⁶ g/mol. The upper limit for the weight-average molecular weight of TPU is generally determined by the processability and the desired range of properties. Preferably the weight-average molecular weight does not exceed 0.8×10⁶ g/mol. The mean molecular weights and the weight-average molecular weight as outlined herein are determined by gel permeation chromatography, preferably according to DIN 55672-1.

The isocyanate preferably is an organic isocyanate, more preferred is a diisocyanate. Further preferred the isocyanate is selected from the group consisting of aliphatic, cycloaliphatic, araliphatic and aromatic isocyanates, or is a mixture thereof. More preferably the isocyanate is an aliphatic isocyanate, more preferably selected from the group consisting of tri-, tetra-, penta-, hexa-, hepta- and/or octamethylene diisocyanate, 2-methyl-pentamethylene 1,5-diisocyanate, 2-ethyl-butylene-1,4-diisocyanate, 1,5-pentamethylene diisocyanate (PDI), 1,4-butylene-diisocyanate, 1-isocyanato-3,3,5-trimethyl-5-isocyanatomethyl-cyclohexane (isophorone diisocyanate, IPDI), 1,4-bis(isocyanatomethyl)cyclohexane and/or 1,3-bis(isocyanatomethyl)cyclohexane (HXDI), 4,4′-, 2,4′- and 2,2′-dicyclohexylmethane diisocyanate (H12MDI), 1,6-hexamethylene diisocyanate (HDI), 1,4-cyclohexane diisocyanate, 1-methyl-2,4- and/or -2,6-cyclohexane diisocyanate, or is a mixture thereof.

Aliphatic isocyanates are preferred since they show better stability against electromagnetic waves e.g. light. A further advantage of aliphatic isocyanate is that it may be produced biobased.

More preferred the aliphatic isocyanate is selected from the group of 1,5-pentamethylene diisocyanate, 4,4′-, 2,4′- and 2,2′-dicyclohexylmethane diisocyanate (H12MDI), 1-isocyanato-3,3,5-trimethyl-5-isocyanatomethyl-cyclohexane (isophorone diisocyanate, IPDI), or is a mixture thereof. The use of 1,5-pentamethylene diisocyanate has the additional advantage, that it can be produced bio based.

A very preferred aliphatic isocyanate is 4,4′-, 2,4′- and 2,2′-dicyclohexylmethane diisocyanate (H12MDI), especially preferred is 4,4′-, 2,4′- and 2,2′-dicyclohexylmethane diisocyanate.

According to a further embodiment, the present invention is also directed to the particle as described above, wherein the diisocyanate (I-A) is an aliphatic diisocyanate, preferably selected from the group consisting of tri-, tetra-, penta-, hexa-, hepta- and/or octamethylene diisocyanate, 2-methyl-pentamethylene 1,5-diisocyanate, 2-ethyl-butylene-1,4-diisocyanate, 1,5-pentamethylene diisocyanate (PDI), 1,4-butylene-diisocyanate, 1-isocyanato-3,3,5-trimethyl-5-isocyanatomethyl-cyclohexane (isophorone diisocyanate, IPDI), 1,4-bis(isocyanatomethyl) cyclohexane and/or 1,3-bis(isocyanatomethyl)cyclohexane (HXDI), 4,4′-, 2,4′- and 2,2′-dicyclohexylmethane diisocyanate (H12MDI), 1,6-hexamethylene diisocyanate (HDI), 1,4-cyclohexane diisocyanate, 1-methyl-2,4- and/or -2,6-cyclohexane diisocyanate, or is a mixture thereof, more preferably is 4,4′-, 2,4′- and 2,2′-dicyclohexylmethane diisocyanate (H12MDI). 1-isocyanato-3,3,5-trimethyl-5-isocyanatomethylcyclohexane (isophorone diisocyanate, IPDI) or H12MDI.

In a preferred embodiment prepolymers, which are the reaction product of polymer diol and isocyanate are used, preferably those containing free isocyanate groups. The NCO content of these prepolymers is preferably between 10% and 25%. The prepolymers offer the advantage that due to the preliminary reaction during the preparation of the prepolymers, a lower reaction time is needed for the preparation of the thermoplastic polyurethanes itself.

According to the present invention, the properties of composition (A) and (B) are adapted depending on the use of the particles and the ratio of composition (A) and (B) present in the particles obtained.

In a preferred embodiment, the Shore A hardness of the composition (A) is less than 80, preferably less than 70, more preferably less than 65, more preferably less than 60, more preferably less than 55 and more preferably less than 50.

In a further embodiment, the Shore A hardness of the composition (B) preferably is more than 85 Shore A, preferably more than 90 Shore A, more preferably more than 30 Shore D, more preferably more than 40 Shore D and most preferred more than 55 Shore D, and at the same time, less than 180 Shore D, more preferably less than 150 Shore D.

According to a further embodiment, the present invention is also directed to the particle as described above, wherein the Shore A hardness of the composition (A) measured according to DIN-ISO 7619-1 (2016) is less than 80, preferably less than 70, more preferably less than 65, more preferably less than 60, more preferably less than 55 and more preferably less than 50.

According to a further embodiment, the present invention is also directed to the particle as described above, wherein the Shore D hardness of composition (B) measured according to DIN-ISO 7619-1 (2016) is more than 30, preferably more than 40, preferably more than 55.

In a preferred embodiment the Shore hardness of the composition (A) respectively composition (B) in the particle is determined via a nanoindenter method. The particle preferably is cut perpendicular to the surface to obtain a cross-section-area. The cutting process preferably is done after cooling the particle. Preferably the particle is cooled under the glass transition temperature of both, composition (A) and composition (B), Preferably the cooling is below minus 8×10 °C. The cooling preferably takes place in liquid nitrogen, more preferably in nitrogen with a temperature below minus 8×10 °C. Cutting at low temperature prevents grooves which later disturb the measurement of the hardness.

For preparation, the encapsulated particle is cut to obtain a cross-section-area. The cutting process is conducted below glass transition temperature via cryo-sectioning using a microtome like Ultramicrotome Leica EM UC7 to prevent grooves which later disturb the actual measurement. For cooling, the particle is dipped into liquid nitrogen. Afterwards, it is fixed via a specimen holder and subsequently trimmed with a diamond knife to prepare an ultra-flat block face surface. During the subsequent warm-up of the specimen at room temperature, it is covered under nitrogen atmosphere to avoid intensive ice/water condensation.

The actual indenter measurement follows DIN EN ISO 14577-1. As indenter a Berkovich-tip (α=65.27°) may be used and the test usually is conducted via load control method with a XP indentation head. The load is set to 1 mN for shoreD material and 0.3 mN for shoreA. Multiple nano indenter measures, preferably 10 measure, at the core (component A) and shell area (component B) are conducted to obtain an average value.

The correlation between the measured values obtained by the nanoindenter method and the Shore hardness is determined as shown in FIG. 3 and FIG. 4.

The Shore hardness of composition (A) and (B) may be adjusted by the building component used and also the ratio of the isocyanate and the polyol composition. Also the ratio of polyol and chain extender used may be adapted to change the Shore hardness of the polyurethane obtained.

For the preparation of the polyurethane (PU-A) and (PU-B), one or more polyols are used. Customary polyols are known to the skilled person. Polyols which can be used in the context of the present invention are, in particular, well-known polyhydroxyl compounds. The polyol has on statistical average at least 1.8 and at most 2.4 Zerewitinoff-active hydrogen atoms, this number is also referred to as the functionality of the polymer diol and indicates the quantity of the isocyanate-reactive groups of the molecule calculated theoretically down to one molecule from a quantity of substance. The functionality is further preferred between 1.9 and 2.2 and especially preferred 2. Compounds reactive with isocyanates are preferably those having a molecular weight between 0.5×10³ g/mol and 8×10³ g/mol, preferably between 0.7×10³ g/mol and 6.0×10³ g/mol, in particular between 0.8×10³ g/mol and 4.0×10³ g/mol.

The polyol is a single compound or is a mixture of different such compounds, in which case the mixture meets the above requirement.

These long-chain compounds typically are used with a content of 1 mol % equivalent to 80 mol % equivalent, based on the isocyanate group content of the polyisocyanate.

The polyol preferably is selected from the group consisting of polyesterols, polyetherols or polycarbonate diols, more preferred from the group consisting of polyether polyol and polycarbonate. Particularly preferred is polyether polyol. More preferably the polyol is a polymer diol.

Polyols selected from the following group are preferred: copolyesters based on adipic acid, succinic acid, pentanedioic acid, sebacic acid or mixtures thereof and mixtures of 1,2-ethanediol and 1,4-butanediol, copolyesters based on adipic acid, succinic acid, pentanedioic acid, sebacic acid or mixtures thereof and mixtures of 1,4-butanediol and 1,6-hexanediol, polyesters based on adipic acid and 3-methyl-pentanediol-1,5 and/or polytetramethylene glycol (polytetrahydrofuran, PTHF), particularly preferably copolyester based on adipic acid and mixtures of 1,2-ethanediol and 1,4-butanediol or polyester based on adipic acid, succinic acid, pentanedioic acid, sebacic acid or mixtures thereof and polytetramethylene glycol (PTHF) or mixtures thereof.

Preferred polyether polyols are polyether diols, further preferred those based on ethylene oxide, propylene oxide and/or butylene oxide.

Another preferred polyether is polytetrahydrofuran (PTHF). In a preferred embodiment the polytetrahydrofuran has a number average molecular weight between 0.6×10³ g/Mol and 1.7×10³ g/Mol determined according to DIN 55672-1, more preferably with a number average molecular weight between 0.8×10³ g/Mol and 1.4×10³ g/Mol, even more preferably with a number average molecular weight between 0.9×10³ g/Mol and 1.1×10³ g/Mol, and most preferably 1.0×10³ g/Mol.

The number average molecular weight Mn in the context of this invention is preferably determined according to DIN 55672-1.

According to a further embodiment, the present invention is also directed to the particle as described above, wherein the diol (D-A) is a polyether diol, more preferably with a molecular weight between 0.5×10³ g/mol and 1.5×10³ g/mol, more preferably between 0.8×10³ g/mol and 1.2×10³ g/mol, most preferably 1.0×10³ g/mol., most preferably a polytetrahydrofuran.

Polyether polyols are obtained by known methods, such as but not limited to, reaction between at least one starter molecule, such as ethylene glycol, propylene glycol, glycerine, pentaerythritol, trimethylolpropane, sucrose, or sorbitol, and alkylene oxide such as EO, PO, mixtures of EO and PO or tetrahydrofuran.

Preferred polyether polyols include polytetramethylene ether glycol (also referred as PTMEG), polypropylene oxide glycol and polybutylene oxide glycol. Particularly preferred is PTMEG or α-hydro-ω-hydroxypoly (oxy tetra-methylene) diol, preferably having a number average molecular weight Mn between 500 g/mol and 3.0×10³ g/mol, preferably between 600 g/mol and 2.0×10³ g/mol, more preferably between 700 g/mol and 1.8×10³ g/mol. They are commercially available under the tradename PolyTHF®.

Polyetherpolyol has the advantage that it is more stable against hydrolysis and thus will be applied in applications where this is a requirement

Suitable polyester polyols may also be selected from the group consisting of reaction product of polyhydric alcohol, polymerization product of lactone and polymerization product of di-carboxylic acids with polyhydric alcohols. By the term “lactone”, it is referred to cyclic esters of hydroxycarboxylic acids. Such polyester polyols include hydroxyl-terminated reaction products of polyhydric alcohols, polyester polyols obtained as the polymerization product of lactone, e.g. caprolactone, in conjunction with a polyol, and polyester polyols obtained by the polymerization of a dicarboxylic acid, e.g. adipic acid, with a polyhydric alcohol. Preferred polyester polyols include polymerization product of lactone or polycaprolactone and the ones obtained by the polymerization of a di-carboxylic acid with a polyhydric alcohol.

In a preferred embodiment, the polyester polyol obtained by polymerization of di-carboxylic acid with polyhydric alcohol is employed. Suitable di-carboxylic acid is at least one of C4 to C12 dicarboxylic acid, while at least one of C2 to C14 diol are suitable as polyhydric alcohols. Preferably, C4 to C12 dicarboxylic acid are selected from the group consisting of aliphatic dicarboxylic acid such as succinic acid, glutaric acid, adipic acid, suberic acid, azelaic acid and sebacic acid and aromatic dicarboxylic acid such as phthalic acid, isophthalic acid and terephthalic acid. More preferably, the dicarboxylic acid is selected from the group consisting of succinic acid, glutaric acid, adipic acid, suberic acid, phthalic acid, isophthalic acid and terephthalic acid. most preferably, it is selected from the group consisting of adipic acid, suberic acid and phthalic acid. These dicarboxylic acids can be utilized individually or in the form of mixtures.

Preferably, C2 to C14 diol is selected from the group consisting of ethylene glycol, diethylene glycol, 1,4-butanediol, 1,5-pentanediol, 1,6-hexanediol, 1,10-decanediol, 2,2-dimethyl-propane-1,3-diol, 1,3-propanediol, 2-methyl-1,3-propanediol and dipropylene glycol can be used individually or as mixtures. More preferably, it is selected from the group consisting of ethylene glycol, diethylene glycol, 1,4-butanediol, 1,5-pentanediol, 1,6-hexanediol, 1,10-decanediol or a mixture thereof. Most preferably, it is selected from the group consisting of 1,4-butanediol, 1,5-pentanediol, 1,6-hexanediol, 1,10-decanediol or a mixture thereof.

Polyesters have less stability against hydrolysis and are preferred in applications where biodegradability is required.

In another preferred embodiment the polyol is a polycarbonate diol, preferably an aliphatic polycarbonate diol. Typically, polycarbonatediols have better permeability for microwave, less dirt uptake and show better flame retardancy. Preferred polycarbonate diols are, for example, polycarbonate diols based on alkanediols. Preferred polycarbonate diols are strictly difunctional OH-functional polycarbonate diols, preferably strictly difunctional OH-functional aliphatic polycarbonate diols. Preferred polycarbonate diols are based on butanediol, pentanediol or hexanediol, in particular 1,4-butanediol, 1,5-pentanediol, 1,6-hexanediol, 3-methylpentane-(1,5)-diol, or are mixtures thereof, in particular preferably 1,4-butanediol, 1,5-pentanediol, 1,6-hexanediol, or mixtures thereof. Most preferred in the present invention are polycarbonate diols based on butanediol and hexanediol, polycarbonate diols based on pentanediol and hexanediol, polycarbonate diols based on hexanediol, and mixtures of two or more of these polycarbonate diols.

Preferably, the polycarbonate diols used have a number average molecular weight Mn in the range from 0.5×10³ to 4.0×10³ g/mol, determined via GPC, preferably in the range from 0.65×10³ g/mol to 3.5×10³ g/mol determined via GPC, particularly preferred in the range from 0.8×10³ g/mol to 3.0×10³ g/mol, determined via GPC.

In another embodiment the polyol is a polysiloxane diol. Preferably the oligo- or polysiloxane has the formula (I):

HO-[Ak-O]_{q}-Ak-Si(R₂)—[O—Si(R₂)]ₚ—O—Si(R₂)-Ak-[O-Ak]_{q}-OH formula (I)
wherein Ak preferably represents C₂-C₄ alkylene, R represents C₁-C₄ alkyl, and each of p, q and q′ independently is a number selected from the range of 0 to 50. In more preferred moieties (B) of formula (I), p ranges from 1 to 50, especially from 2 to 50.

In one preferred embodiment Ak represents identical alkylene units in each residue (C1), in yet another preferred embodiment Ak represents different alkylene units in the same residue (C1). In one preferred embodiment Ak is ethylene or propylene within the same residue (C1).

One preferred polydimethylsiloxane diol has formula (II)

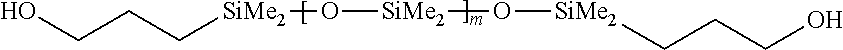

with m in the range from 5 to 80,
or has formula (III)

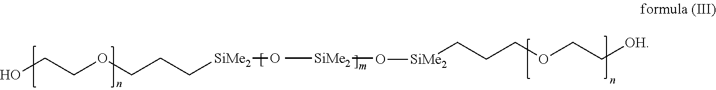

The molecular weight is preferably between 0.500×10³ g/Mol and 15×10³ g/Mol, more preferred between 1.0×10³ g/Mol and 3.0×10³ g/Mol.

In one preferred embodiment the polyol is a mixture of two or more polyols. In one preferred embodiment it is a mixture of at least one polyether polyol and at least one polycarbonate diol.

In a case of using a mixture of polyether polyols and polycarbonate diols, polycarbonate diols are used in amount of less than 50% by weight, preferably less than 35% by weight, more preferably less than 15% by weight, and most preferably less than 5% by weight, based on the total weight of the polyol mixture.

In preferred embodiments a chain extender is used in the synthesis of the polyurethane, preferably the thermoplastic polyurethane. The chain extender preferably is an aliphatic, araliphatic, aromatic and/or cycloaliphatic compound, preferably with a molecular weight of 0.05×10³ g/mol to 0.499×10³ g/mol, preferably with 2 groups reactive with isocyanate, which are also referred to as functional groups. The chain extender is either a single chain extender or a mixture of at least two chain extenders.

The chain extender is preferably a difunctional compound, preferred examples being diamines or alkanediols having 2 to 10 carbon atoms in the alkylene radical, or a mixture thereof.

In a preferred embodiment the chain extender (c) is selected from the group consisting of 1,2-ethylene glycol, 1,2-propanediol, 1,3-propanediol, 1,4-butanediol, 2,3-butanediol, 1,5-pentanediol, 1,6-hexanediol, diethylene glycol, di-, tri-, tetra-, penta-, hexa-, hepta-, okta-, nona- and/or deca alkylene glycole dipropylene glycol, 1,4-cyclohexanediol, 1,4-dimethanol cyclohexane, neopentylglycol and hydroquinone bis(beta-hydroxyethyl) ether (HQEE), or is a mixture thereof.

Preferably the chain extender selected from the group consisting of 1,2-ethylene glycol, 1,3-propanediol, 1,4-butanediol, and 1,6-hexanediol, di-, tri-, tetra-, penta-, hexa-, hepta-, okta-, nona- and/or deca alkylene glycole, preferably respective oligo- and/or polypropylene glycole, or is a mixture thereof.

Particularly preferred chain extender is 1,3-propanediol, 1,4-butanediol or 1,6-hexanediol, or is a mixture thereof.

In one preferred embodiment the chain extender is 1,3-propanediol, 1,4-butanediol, or is a mixture thereof. Most preferred the chain extender is a mixture of 1,3-propanediol and 1,4-butanediol. Preferably the ratio of 4-butanediol to 1,3-propanediol is between 55 to 45 and 80 to 20, more preferred between 60 to 40 and 75 to 25, more preferred between 65 to 35 and 75 to 25.

According to a further embodiment, the present invention is also directed to the particle as described above, wherein the chain extender (CE-A) is selected from the group consisting of 1,2-ethylene glycol, 1,2-propanediol, 1,3-propanediol, 1,4-butanediol, 2,3-butanediol, 1,5-pentanediol, 1,6-hexanediol, diethylene glycol, di-, tri-, tetra-, penta-, hexa-, hepta-, okta-, nona- and/or deca alkylene glycole dipropylene glycol, 1,4-cyclohexanediol, 1,4-dimethanol cyclohexane, neopentylglycol and hydroquinone bis(beta-hydroxyethyl) ether (HQEE), or is a mixture thereof, preferably the chain extender (CE-A) is selected from the group consisting of 1,2-ethylene glycol, 1,3-propanediol, 1,4-butanediol, and 1,6-hexanediol, di-, tri-, tetra-, penta-, hexa-, hepta-, okta-, nona- and/or deca alkylene glycole, preferably respective oligo- and/or polypropylene glycole, or is a mixture thereof, more preferably the chain extender (CE-A) is selected from the group consisting of 1,3-propaned diol or 1,4-butane diol, or is a mixture thereof, most preferably the chain extender (CE-A) is a mixture of 1,3-propaned diol or 1,4-butane diol.

To adjust the hardness of the thermoplastic polyurethanes it is possible to vary the amounts of the synthesis components used within relatively broad molar ratios, with the hardness customarily increasing as the amount of chain extender goes up. The mixing ratio of the components used is preferably adjusted so as to give a thermoplastic polyurethane having a Shore hardness in the ranges set out above.

For the preparation of the polyurethane, catalysts may be employed. Catalysts which, in particular, accelerate the reaction between the NCO groups of the isocyanates and the hydroxyl groups of the polyol and the chain extender, are for example selected from the group consisting of tertiary amines and organic metal compound, or mixtures thereof.

A preferred tertiary amine is selected from the group consisting of triethylamine, dimethylcyclohexylamine, N-methylmorpholine, N,N′-dimethyl-piperazine, 2-(dimethylaminoethoxy) ethanol, diazabicyclo[2.2.octane] or is a mixture thereof.

A preferred organic metal compound is selected from the group consisting of titanic ester, iron compound, tin compound, and bismuth salt, or is a mixture thereof. A preferred iron compound is iron (III) acetylacetonate. A preferred tin compound is selected from the group consisting of tin diacetate, tin dioctoate, tin dilaurate and dialkyl tin salts of aliphatic carboxylic acids, preferably tin dioctoate, or is a mixture thereof. A preferred titanic ester is tetrabutyl orthotitanate. In preferred bismuth salts, the bismuth is present in the oxidation states 2 or 3, in particular 3, with preference being given to salts of carboxylic acids, preferably carboxylic acids having from 6 to 14 carbon atoms, particularly preferably from 8 to 12 carbon atoms. A very preferred bismuth salt is bismuth(III) neodecanoate, bismuth 2-ethylhexanoate, or bismuth octanoate, or is a mixture thereof.

The catalyst is preferably used in an amount of from 0.0001 to 0.1 part by weight per 100 parts by weight of the compound reactive toward isocyanates, preferably polyol. Preference is given to using tin catalysts, in particular tin dioctoate.

A very preferred catalyst is SDO (tin (II) 2-ethylhexanoate), preferably used in quantities of 0.35-0.4 parts per weight, referring to the composition.

Furthermore, auxiliaries or additives may be added to the composition/building components. Preferred examples include surface-active substances, fillers, flame retardants, nucleating agents, oxidation stabilizers, lubricating and demolding aids, dyes and pigments, if necessary stabilizers, preferably against hydrolysis, light, heat or discoloration, inorganic and/or organic fillers, reinforcing agents and/or plasticizers.

Stabilizers in the sense of this invention are additives which protect a plastic or a plastic composition against harmful environmental influences. Preferred examples are primary and secondary antioxidants, sterically hindered phenols, hindered amine light stabilizers, UV absorbers, hydrolysis inhibitors, quenchers, and flame retardants. Examples of commercial stabilizers are given in Plastics Additives Handbook, 5th Edition, H. Zweifel, ed., Hanser Publishers, Munich, 2001 ([1]), p. 98-S136.

In a preferred embodiment, the UV absorber has a number average molecular weight greater than 0.3×10³ g/Mol, in particular greater than 0.39×10³ g/Mol. Furthermore, the preferred UV absorber has a molecular weight not exceeding 5×10³ g/Mol, particularly preferred not exceeding 2×10³ g/mol.

The UV absorber is preferably selected from the group consisting of cinnamates, oxanilides and benzotriazole, or is a mixture thereof, particularly suitable as UV absorbers is benzotriazole. Examples of particularly suitable UV-absorbers are Tinuvin® 213, Tinuvin® 234, Tinuvin® 312, Tinuvin® 571, Tinuvin® 384 and Eversorb® 82.

Preferably the UV absorbers is added in quantities of 0.01 wt. % to 5 wt. % based on the total weight of the composition, preferably 0.1 wt. % to 2.0 wt. %, in particular 0.2 wt. % to 0.5 wt. %.

Often a UV stabilization based on an antioxidant and a UV absorber as described above is not sufficient to guarantee a good stability of the composition against the harmful influence of UV rays. In this case, in addition to the antioxidant and/or the UV absorber, or as single stabilizer, a hindered-amine light stabilizer (HALS) is be added to the composition.

Examples of commercially available HALS stabilizers can be found in Plastics Additive Handbook, 5th edition, H. Zweifel, Hanser Publishers, Munich, 2001, pp. 123-136.

Particularly preferred hindered amine light stabilizers are bis-(1,2,2,6,6-penta-methylpiperidyl) sebacat (Tinuvin® 765, Ciba Spezialitätenchemie AG) and the condensation product of 1-hydroxyethyl-2,2,6,6-tetramethyl-4-hydroxypiperidine and succinic acid (Tinuvin® 622). In particular, the condensation product of 1-hydroxyethyl-2,2,6,6-tetramethyl-4-hydroxypiperidines and succinic acid (Tinuvin® 622) is preferred, if the titanium content of the finished product is less than 150 ppm, preferably less than 50 ppm, in particular less than 10 ppm, based on the components used.

HALS compounds are preferably used in a concentration of from 0.01 wt. % to 5 wt. %, particularly preferably from 0.1 wt. % to 1 wt. %, in particular from 0.15 wt. % to 0.3 wt. %, based on the total weight of the composition.

A particularly preferred UV stabilization contains a mixture of a phenolic stabilizer, a benzotriazole and a HALS compound in the preferred amounts described above.

Further information on the above-mentioned auxiliaries and additives can be found in the technical literature, e.g. Plastics Additives Handbook, 5th edition, H. Zweifel, ed., Hanser Publishers, Munich, 2001.

According to the present invention, it is also possible that the amount of additives used in composition (A) and (B) varies. It might for example be possible that the composition (A) only contains little or no additives and that composition (B) contains additives, for example stabilizers.

According to a further aspect, the present invention is also directed to a granulate comprising particles according to the present invention.

Another aspect of the invention is the production of the particles according to the present invention.

The composition comprising the thermoplastic polyurethane (PU-A) or PU-(B) may be produced discontinuously or continuously. A preferred process for preparing composition (A) and/or (B) is for example the reaction extruder process, the belt line process, the “one shot” process, preferably the “one-shot” process or the reaction extruder process, most preferably the reaction extruder process.

These processes are used either by directly mixing the building components or alternatively by applying the prepolymer process.

Polyisocyanate prepolymers are obtainable by reacting above-described polyisocyanate in excess, at temperatures of 30 °C to 100 °C, preferably at 8×10 °C, with the compound reactive isocyanate, preferably the polyol.

In the “one-shot” process, the building components diisocyanate and the compound reactive with isocyanate, preferably polyol, more preferably polyol diol, and in a further preferred embodiment also the chain extender, are mixed with each other. This is done either in succession or simultaneously, in a preferred embodiment in the presence of the catalyst. In the extruder process, the building components diisocyanate and compound reactive with isocyanate, preferably the polyol, more preferably the diol, in a preferred embodiment also the chain extender, and, in further preferred embodiments, also the catalyst are mixed. The mixing in the reaction extruding process is done preferably at temperatures between 100 °C and 280 °C, preferably between 140 °C and 250 °C. The thermoplastic polyurethane obtained, preferably is in the form of a granulate or a powder. Auxiliaries and additives may be added during the synthesis of the thermoplastic polyurethane or are added to the thermoplastic polyurethane. The latter is preferred. This is especially the case, if the additive or auxiliary is not inert against the isocyanate, the chain extender, the compound reactive with isocyanate, or the catalyst.

The auxiliaries may be added during synthesis of the thermoplastic polyurethane. In another preferred embodiment the auxiliary is added to the thermoplastic polyurethane after its synthesis.

In a preferred embodiment the synthesis of the thermoplastic polyurethane is done in an extruder, more preferably a twin-screw extruder is used. The twin-screw extruder operates with positive conveying and thus allows a more precise setting of the temperature and output quantity on the extruder.

According to the present invention, it is also possible that composition (A) and composition (B) are prepared using different processes.

The input materials of the composition (A) and the composition (B) preferably are those as outlined above. Typically, the thermoplastic polyurethane (PU-A) is the reaction product of the following building components: a diisocyanate (I-A), a diol (D-A) and optionally a chain extender (CE-A), and the thermoplastic polyurethane (PU-B) is the reaction product of the following building components: a diisocyanate (I-B), a diol (D-B) and optionally a chain extender (CE-B) and at least one of the building components of the thermoplastic polyurethane (PU-A) and the thermoplastic polyurethane (PU-B) comprises at least one similar building component, more preferably comprises an similar diol and an similar diisocyanate, even more preferably comprises an similar diol, an similar isocyanate, and an similar chain extender. Similar in this context means, that in case at least one of building components is a mixture of at least two substances, at least one of these at least two substances is chemically identical in the thermoplastic polyurethane (PU-A) and in the thermoplastic polyurethane (PU-B).

Preferably, the building components and the ratios used are chosen to adjust the Shore hardness of composition (A) and (B) in the ranges as set out above. Preferably, the Shore hardness of composition (A) is in the range of from 30A to 95 A and the Shore hardness of composition (B) preferably is in the range of from 95A to 80D.

Most preferred all building components of the thermoplastic polyurethane (PU-A) and (PU-B) are similar, most preferred all building components are identical.

In a preferred embodiment the diol (D-A) or the diol (D-B) comprises polytetrahydrofuran, more preferably the diol (D-A) and the diol (D-B) comprises polytetrahydrofuran, and the diisocyanate (I-A) and the diisocyanate (I-B) comprises 4,4′-, 2,4′- and 2,2′-dicyclohexylmethane diisocyanate (H12MDI), more preferably the diol (D-A) and the diol (D-B) comprises polytetrahydrofuran, and the diisocyanate (I-A) and the diisocyanate (I-B) comprises 4,4′-, 2,4′- and 2,2′-dicyclohexylmethane diisocyanate (H12MDI), and the chain extender comprises butanediol and propanediol, more preferably the ratio of 1,4-butanediol to 1,3-propanediol in the chain extender is between 55 to 45 and 80 to 20, more preferred between 60 to 40 and 75 to 25, more preferred between 65 to 35 and 75 to 25

Typically, the Vicat softening temperature of the composition (B) is between 150 °C and 300 °C, more preferred between 175 °C and 230 °C. The Vicat softening temperature preferably is determined according to DIN EN ISO 306 “10N and 120 °C/h (VST A 120)”

Suitable processes for covering a composition or particles are in principle known from the state of the art. Preferably, the composition (A) is covered with composition (B) in the preparation process of the particles.

According to a further aspect, the present invention is also directed to a process for producing the particle according to the present invention comprising the steps
(i) extruding a skein (S-A) of the composition (A),
(ii) covering the skein (S-A) with composition (B) to form a skein (S-AB) and
(iii) forming particles from the skein (S-AB).

Suitable processes may for example include coextrusion of composition (A) and composition (B).

According to a further embodiment, the present invention is also directed to the process for producing the particle as described above, wherein skein (S-A) is coextruded with a tubular skein (S-B) of composition (B) to form a skein (S-AB).

The coextrusion therefore result in a filled tube with a core consisting of composition (A) surrounded by the tube consisting of composition (B). Subsequently, particles are formed from the skein, for example crimping or cutting.

According to a further embodiment, the present invention is also directed to the process for producing the particle as described above, wherein the skein (S-AB) is crimped to form pellets.

According to the present invention it is also possible to prepare the particle by a process which includes producing a layer or a skein of the composition (A), cover this layer or skein with composition (B) to an intermediate product and in a second step forming the particle from the intermediate product. This forming preferably is done by crimping, cutting, wrenching, twisting or a combination thereof.

According to the present invention it is also possible to prepare a particle of composition (A) which is subsequently covered with composition (B), i.e. composition (A) is formed to a pellet, which in a second step is covered with composition (B).

Covering the composition (A) at least partly with the composition (B) preferably is done by a process selected from spray coating, spray coating in a fluidized bed, co-extrusion, dip coating, brushing, pan coating.

It has been found that it is particularly advantageous to prepare is derived from a co-extruded intermediate product with a coaxial structure of composition (A) and composition (B). The core skein of the intermediate product usually comprises the composition (A) and the outer skein comprises the composition (B).

In a further embodiment of the present invention, the particles are derived from an intermediate product with sandwich layer structure. The layer of composition (A) preferably is covered by two layers of composition (B) to form a sandwich layer structure with a layer of composition (B) at the bottom and the top and a layer of composition (A) between these two layers. Preferably the intermediate sandwich product is co-extruded.

Co-extruding the intermediate sandwich product preferably means that composition (B) and composition (A) is molten. Preferably melting takes place in an extruder. The molten composition (A) and composition (B) preferably are guided to a flat sheet co-extrusion die. The die forms a sandwich sheet comprising of composition (A) as middle part and a top and bottom layer comprising of the composition (B). Preferably the co-extruded intermediate product is chilled or planed via a calender unit or both.

Preferably the temperature in the co-extrusion process is between 180 °C and 220 °C.

The intermediate product may be formed into the particle, preferably by cutting or crimping.

Crimping is preferred since crimping allows to more completely encapsulating the composition (A) with composition (B) in the particle.

The temperature of crimping is a critical parameter and strongly depends on the speed of the crimping process, the formula of the composition, the chilling temperature, the layer thicknesses and the material and design of the crimping device. On the one hand the melt is chilled, and the obtained sheet requires a sufficient elongation stability to maintain the web tension for further guidance and on the other hand the plastic deformability of the compositions (A) and (B) has to be set in a certain range to allow the subsequent crimp and cut device to provide the fully encapsulated articles.

By variating the dosing ratio between composition (A) and composition (B) and the haul-off speed of the strand towards the sealing device, the thickness of core and shell are adjusted. The obtained pellets are then cooled either by a water bath or nozzles preferably by spraying water on the particles.

In a preferred embodiment, the particle may be cured by ultra-violet light (UV curing).

According to a further aspect, the present invention is also directed to a process for producing an article using particles as described above or a granulate as described above.

Another aspect of this invention therefore is a foamed bead or a foamed particle made of the particles according to the present invention.

The foamed beads and also molded bodies produced therefrom may be used in various applications (see e.g. WO 94/20568, WO 2007/082838 A1, WO2017030835, WO 2013/153190 A1, WO2010010010), herein incorporated by reference

Another aspect of the invention is the use of the particles according to the present invention for producing an article.

The production of these articles is preferably done by injection moulding, calandering, producing of films, powder sintering, or extrusion.

The particles in a preferred embodiment are for example injection moulded, calendered, powder sintered, or extruded to form an article.

Yet another aspect of the invention is the article produced using the particles according to the present invention or as obtained by the process according to the invention.

Preferably the article is selected from the group consisting of cables, cases, cell-phone, coating, covers, damping element, bellows, foil, fiber, film moulded body, roofing or flooring for buildings or vehicles, non woven fabric, gasket, packaging material, roll, shoe sole, middle sole of a shoe, hose, cable, cable connector, cable sheathing, pillow, laminate, phone, profile, strap, saddle, foam, by additional foaming of the preparation, plug connection, television, trailing cable, solar module, lining in automobiles, wiper blade, elevator load bearing members, roping arrangements, drive belts for machines, preferably passenger conveyer, handrails for passenger conveyers modifier for thermoplastic materials, which means substance that influences the properties of another material. Each of these articles itself is a preferred embodiment, also referred to as an application.

More preferably the product is selected from covers, packaging material, cases, phone, cell phones, television, or cable, more preferably for electronic device.

### BRIEF DESCRIPTION OF THE FIGURES

FIG. 1 shows a co-extrusion equipment. The composition (A) is fed into a coextrusion die (3) via a melt channel (1). Composition (B) is fed into the coextrusion die (3) in a melt channel (2). Melt channel (1) and (2) are combined so that an intermediate product (5) with a core-of composition (A) covered with composition (B) leaves the coextrusion die (3). Cooling (4) may be applied. The intermediate product (5) is crimped by a sealing device (6) to form the particles (7).

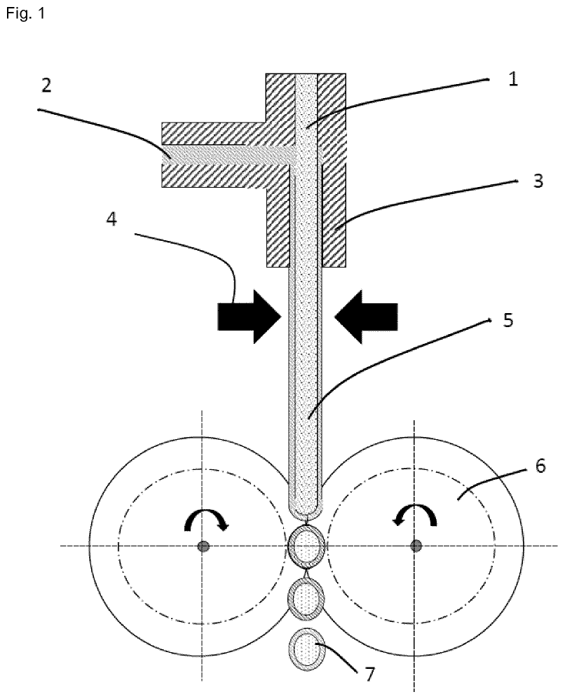

FIG. 2 depicts a calendar device with a coextrusion die (3) for a sandwich sheet. The composition (A) is fed into the coextrusion die (3) via a melt channel (1). Composition (B) is fed into the coextrusion die (3) via a melt channel (2). Melt channel (1) and (2) are combined so that an intermediate product (5), a sandwich sheet with a core-sheet of composition (A) covered with two sheets of composition (B) leaves the coextrusion die (3). The intermediate product (5) is crimped by a sealing device (6) to form the particles (7).

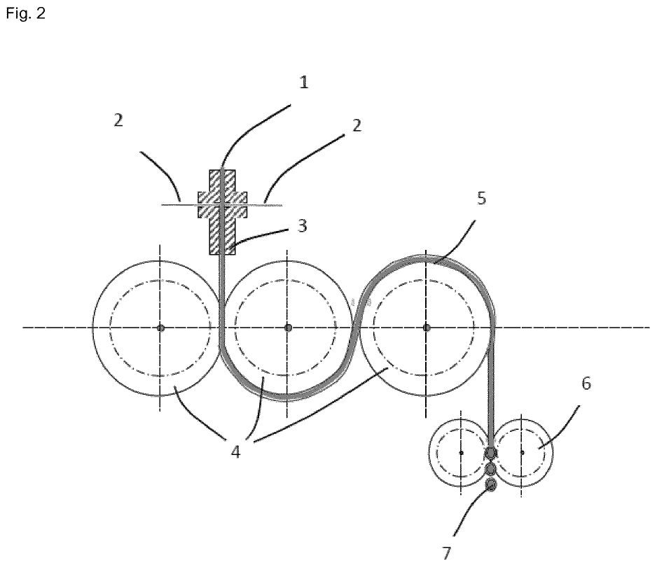

FIG. 3 shows the correlation between the Shore A hardness on the x axis and the hardness determined with the nanindentation methode on the y axis (hardness in MPa).

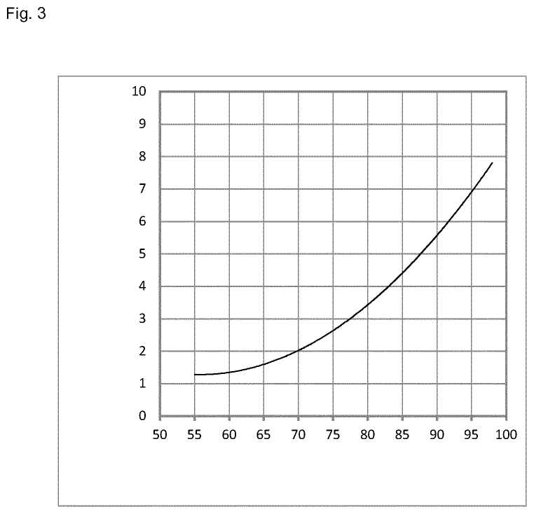

FIG. 4 shows the correlation between the Shore D hardness on the x axis and the hardness determined with the nanindentation methode on the y axis (hardness in MPa).

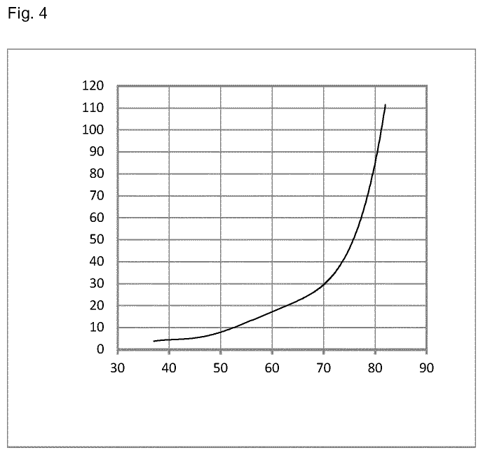

Further embodiments of the present invention can be found in the claims and the examples. It will be appreciated that the features of the subject matter/processes/uses according to the invention that are mentioned above and elucidated below are usable not only in the combination specified in each case but also in other combinations without departing from the scope of the invention. For example, the combination of a preferred feature with a particularly preferred feature or of a feature not characterized further with a particularly preferred feature etc. is thus also encompassed implicitly even if this combination is not mentioned explicitly.

Illustrative embodiments of the present invention are listed below, but these do not restrict the present invention. In particular, the present invention also encompasses those embodiments which result from the dependency references and hence combinations specified hereinafter.
1. Particle comprising a composition (A) comprising a thermoplastic polyurethane (PU-A), and a composition (B) comprising a thermoplastic polyurethane (PU-B), wherein the composition (A) is at least partly covered with the composition (B).
2. Particle (P) comprising a particle comprising composition (A) comprising a thermoplastic polyurethane (PU-A), and a composition (B) comprising a thermoplastic polyurethane (PU-B), wherein the particle comprising composition (A) is at least partly covered with the composition (B).
3. Particle according to any of embodiments 1 or 2, wherein the thermoplastic polyurethane (PU-A) is the reaction product of the following building components:
   a diisocyanate (I-A), a diol (D-A) and optionally a chain extender (CE-A), and the thermoplastic polyurethane (PU-B) is the reaction product of the following building components: a diisocyanate (I-B), a diol (D-B) and optionally a chain extender (CE-B),
   and at least one of the building components of the thermoplastic polyurethane (PU-A) and the thermoplastic polyurethane (PU-B) is at least partly the same,
   more preferably the diol (D-A) and (D-B) and the diisocyanate (I-A) and (I-B) are at least partly the same, even more preferably, the diol (D-A) and (D-B), the diisocyanate (I-A) and (I-B), and at least the chain extender (CE-A) and (CE-B) is at least partly the same.
4. Particle according to any of embodiments 1 to 3, wherein at least 50% of the surface of the composition (A) is covered by composition (B), preferably at least 60% of the surface, more preferable at least 70% of the surface, in particular at least 80% of the surface, most preferable at least 90% of the surface.
5. Particle according to any of embodiments 1 to 4, wherein the composition (A) is completely covered by composition (B).
6. Particle according to any of embodiments 1 to 5, wherein the composition (A) is covered with a film of composition (B) and the film of composition (B) preferably has a thickness of less than 1 mm, more preferably less than 0.5 mm, more preferably less than 0.1 mm.
7. Particle according to any of embodiments 1 to 6, wherein the particle comprising composition (A) is covered with a film of composition (B) and the film of composition (B) preferably has a thickness of less than 1 mm, more preferably less than 0.5 mm, more preferably less than 0.1 mm.
8. Particle according to any of embodiments 1 to 7, wherein the diisocyanate (I-A) is an aliphatic diisocyanate, preferably selected from the group consisting of tri-, tetra-, penta-, hexa-, hepta- and/or octamethylene diisocyanate, 2-methyl-pentamethylene 1,5-diisocyanate, 2-ethyl-butylene-1,4-diisocyanate, 1,5-pentamethylene diisocyanate (PDI), 1,4-butylene-diisocyanate, 1-isocyanato-3,3,5-trimethyl-5-isocyanatomethyl-cyclohexane (isophorone diisocyanate, IPDI), 1,4-bis(isocyanatomethyl)cyclohexane and/or 1,3-bis(isocyanatomethyl)cyclohexane (HXDI), 4,4′-, 2,4′- and 2,2′-dicyclohexylmethane diisocyanate (H12MDI), 1,6-hexamethylene diisocyanate (HDI), 1,4-cyclohexane diisocyanate, 1-methyl-2,4- and/or -2,6-cyclohexane diisocyanate, or is a mixture thereof, more preferably is 4,4′-, 2,4′- and 2,2′-dicyclohexylmethane diisocyanate (H12MDI). 1-isocyanato-3,3,5-trimethyl-5-isocyanatomethylcyclohexane (isophorone diisocyanate, IPDI) or H12MDI.
9. Particle according to one of embodiments 1 to 8, wherein the Shore A hardness of the composition (A) measured according to DINISO 7619-1 (2016) is less than 80, preferably less than 70, more preferably less than 65, more preferably less than 60, more preferably less than 55 and more preferably less than 50.
10. Particle according to one of embodiments 1 to 9, wherein the diol (D-A) is a polyether diol, more preferably with a molecular weight between 0.5×103 g/mol and 1.5×103 g/mol, more preferably between 0.8×103 g/mol and 1.2×103 g/mol, most preferably 1.0×103 g/mol., most preferably a polytetrahydrofuran.
11. Particle according to one of embodiments 1 to 10, wherein the chain extender (CE-A) is selected from the group consisting of 1,2-ethylene glycol, 1,2-propanediol, 1,3-propanediol, 1,4-butanediol, 2,3-butanediol, 1,5-pentanediol, 1,6-hexanediol, diethylene glycol, di-, tri-, tetra-, penta-, hexa-, hepta-, okta-, nona- and/or deca alkylene glycole dipropylene glycol, 1,4-cyclohexanediol, 1,4-dimethanol cyclohexane, neopentylglycol and hydroquinone bis(beta-hydroxyethyl) ether (HQEE), or is a mixture thereof, preferably the chain extender (CE-A) is selected from the group consisting of 1,2-ethylene gly-col, 1,3-propanediol, 1,4-butanediol, and 1,6-hexanediol, di-, tri-, tetra-, penta-, hexa-, hepta-, okta-, nona- and/or deca alkylene glycole, preferably respective oligo- and/or polypropylene glycole, or is a mixture thereof, more preferably the chain extender (CE-A) is selected from the group consisting of 1,3-propaned diol or 1,4-butane diol, or is a mixture thereof, most preferably the chain extender (CE-A) is a mixture of 1,3-propaned diol or 1,4-butane diol.
12. Particle according to one of embodiments 1 to 11, wherein the Shore D hardness of composition (B) measured according to DINISO 7619-1 (2016) is more than 30, preferably more than 40, preferably more than 55.
13. Granulate comprising particles according to any of the embodiments 1 to 12.
14. Granulate comprising particles comprising a composition (A) comprising a thermoplastic polyurethane (PU-A), and a composition (B) comprising a thermoplastic polyurethane (PU-B), wherein the composition (A) is at least partly covered with the composition (B).
15. Granulate comprising particles (P) comprising a particle comprising composition (A) comprising a thermoplastic polyurethane (PU-A), and a composition (B) comprising a thermoplastic polyurethane (PU-B), wherein the particle comprising composition (A) is at least partly covered with the composition (B).
16. Granulate according to any of embodiments 13 to 15, wherein the thermoplastic polyurethane (PU-A) is the reaction product of the following building components:
   a diisocyanate (I-A), a diol (D-A) and optionally a chain extender (CE-A), and the thermoplastic polyurethane (PU-B) is the reaction product of the following building components: a diisocyanate (I-B), a diol (D-B) and optionally a chain extender (CE-B),
   and at least one of the building components of the thermoplastic polyurethane (PU-A) and the thermoplastic polyurethane (PU-B) is at least partly the same,
   more preferably the diol (D-A) and (D-B) and the diisocyanate (I-A) and (I-B) are at least partly the same, even more preferably, the diol (D-A) and (D-B), the diisocyanate (I-A) and (I-B), and at least the chain extender (CE-A) and (CE-B) is at least partly the same.
17. Granulate according to any of embodiments 13 to 16, wherein at least 50% of the surface of the composition (A) is covered by composition (B), preferably at least 60% of the surface, more preferable at least 70% of the surface, in particular at least 80% of the surface, most preferable at least 90% of the surface.
18. Granulate according to any of embodiments 13 or 17, wherein the composition (A) is completely covered by composition (B).
19. Granulate according to any of embodiments 13 to 18, wherein the composition (A) is covered with a film of composition (B) and the film of composition (B) preferably has a thickness of less than 1 mm, more preferably less than 0.5 mm, more preferably less than 0.1 mm.
20. Granulate according to any of embodiments 13 to 19, wherein the particle comprising composition (A) is covered with a film of composition (B) and the film of composition (B) preferably has a thickness of less than 1 mm, more preferably less than 0.5 mm, more preferably less than 0.1 mm.
21. Granulate according to any of embodiments 13 to 20, wherein the diisocyanate (I-A) is an aliphatic diisocyanate, preferably selected from the group consisting of tri-, tetra-, penta-, hexa-, hepta- and/or octamethylene diisocyanate, 2-methyl-pentamethylene 1,5-diisocyanate, 2-ethyl-butylene-1,4-diisocyanate, 1,5-pentamethylene diisocyanate (PDI), 1,4-butylene-diisocyanate, 1-isocyanato-3,3,5-trimethyl-5-isocyanatomethyl-cyclohexane (isophorone diisocyanate, IPDI), 1,4-bis(isocyanatomethyl)cyclohexane and/or 1,3-bis(isocyanatomethyl)cyclohexane (HXDI), 4,4′-, 2,4′- and 2,2′-dicyclohexylmethane diisocyanate (H12MDI), 1,6-hexamethylene diisocyanate (HDI), 1,4-cyclohexane diisocyanate, 1-methyl-2,4- and/or -2,6-cyclohexane diisocyanate, or is a mixture thereof, more preferably is 4,4′-, 2,4′- and 2,2′-dicyclohexylmethane diisocyanate (H12MDI). 1-isocyanato-3,3,5-trimethyl-5-isocyanatomethylcyclohexane (isophorone diisocyanate, IPDI) or H12MDI.
22. Granulate according to one of embodiments 13 to 21, wherein the Shore A hardness of the composition (A) measured according to DINISO 7619-1 (2016) is less than 80, preferably less than 70, more preferably less than 65, more preferably less than 60, more preferably less than 55 and more preferably less than 50.
23. Granulate according to one of embodiments 13 to 22, wherein the diol (D-A) is a polyether diol, more preferably with a molecular weight between 0.5×103 g/mol and 1.5×103 g/mol, more preferably between 0.8×103 g/mol and 1.2×103 g/mol, most preferably 1.0×103 g/mol., most preferably a polytetrahydrofuran.
24. Granulate according to one of embodiments 13 to 23, wherein the chain extender (CE-A) is selected from the group consisting of 1,2-ethylene glycol, 1,2-propanediol, 1,3-propanediol, 1,4-butanediol, 2,3-butanediol, 1,5-pentanediol, 1,6-hexanediol, diethylene glycol, di-, tri-, tetra-, penta-, hexa-, hepta-, okta-, nona- and/or deca alkylene glycole dipropylene glycol, 1,4-cyclohexanediol, 1,4-dimethanol cyclohexane, neopentylglycol and hydroquinone bis(beta-hydroxyethyl) ether (HQEE), or is a mixture thereof, preferably the chain extender (CE-A) is selected from the group consisting of 1,2-ethylene gly-col, 1,3-propanediol, 1,4-butanediol, and 1,6-hexanediol, di-, tri-, tetra-, penta-, hexa-, hepta-, okta-, nona- and/or deca alkylene glycole, preferably respective oligo- and/or polypropylene glycole, or is a mixture thereof, more preferably the chain extender (CE-A) is selected from the group consisting of 1,3-propaned diol or 1,4-butane diol, or is a mixture thereof, most preferably the chain extender (CE-A) is a mixture of 1,3-propaned diol or 1,4-butane diol.
25. Granulate according to one of embodiments 13 to 24, wherein the Shore D hardness of com-position (B) measured according to DINISO 7619-1 (2016) is more than 30, preferably more than 40, preferably more than 55.
26. Process for producing the particle according to one of embodiments 1 to 12 comprising the steps (i) extruding a skein (S-A) of the composition (A),
   (ii) covering the skein (S-A) with composition (B) to form a skein (S-AB) and
   (iii) forming particles from the skein (S-AB).
27. Process according to embodiment 26, wherein skein (S-A) is coextruded with a tubular skein (S-B) of composition (B) to form a skein (S-AB).
28. Process according to one of embodiments 26 or 27, wherein the skein (S-AB) is crimped to form pellets.
29. Process according to any of embodiments 26 to 28, wherein the thermoplastic polyurethane (PU-A) is the reaction product of the following building components:
   a diisocyanate (I-A), a diol (D-A) and optionally a chain extender (CE-A),
   and the thermoplastic polyurethane (PU-B) is the reaction product of the following building components: a diisocyanate (I-B), a diol (D-B) and optionally a chain extender (CE-B),
   and at least one of the building components of the thermoplastic polyurethane (PU-A) and the thermoplastic polyurethane (PU-B) is at least partly the same,
   more preferably the diol (D-A) and (D-B) and the diisocyanate (I-A) and (I-B) are at least partly the same, even more preferably, the diol (D-A) and (D-B), the diisocyanate (I-A) and (I-B), and at least the chain extender (CE-A) and (CE-B) is at least partly the same.
30. Process according to any of embodiments 26 to 29, wherein the composition (A) is covered with a film of composition (B) and the film of composition (B) preferably has a thickness of less than 1 mm, more preferably less than 0.5 mm, more preferably less than 0.1 mm.
31. Process according to any of embodiments 26 to 30, wherein the particle comprising composition (A) is covered with a film of composition (B) and the film of composition (B) preferably has a thickness of less than 1 mm, more preferably less than 0.5 mm, more preferably less than 0.1 mm.
32. Process according to any of embodiments 26 to 31, wherein the diisocyanate (I-A) is an aliphatic diisocyanate, preferably selected from the group consisting of tri-, tetra-, penta-, hexa-, hepta- and/or octamethylene diisocyanate, 2-methyl-pentamethylene 1,5-diisocyanate, 2-ethyl-butylene-1,4-diisocyanate, 1,5-pentamethylene diisocyanate (PDI), 1,4-butylene-diisocyanate, 1-isocyanato-3,3,5-trimethyl-5-isocyanatomethyl-cyclohexane (isophorone diisocyanate, IPDI), 1,4-bis(isocyanatomethyl)cyclohexane and/or 1,3-bis(isocyanatomethyl)cyclohexane (HXDI), 4,4′-, 2,4′- and 2,2′-dicyclohexylmethane diisocyanate (H12MDI), 1,6-hexamethylene diisocyanate (HDI), 1,4-cyclohexane diisocyanate, 1-methyl-2,4- and/or -2,6-cyclohexane diisocyanate, or is a mixture thereof, more preferably is 4,4′-, 2,4′- and 2,2′-dicyclohexylmethane diisocyanate (H12MDI). 1-isocyanato-3,3,5-trimethyl-5-isocyanatomethylcyclohexane (isophorone diisocyanate, IPDI) or H12MDI.
33. Process according to one of embodiments 26 to 32, wherein the Shore A hardness of the composition (A) measured according to DINISO 7619-1 (2016) is less than 80, preferably less than 70, more preferably less than 65, more preferably less than 60, more preferably less than 55 and more preferably less than 50.
34. Process according to one of embodiments 26 to 33, wherein the diol (D-A) is a polyether diol, more preferably with a molecular weight between 0.5×103 g/mol and 1.5×103 g/mol, more preferably between 0.8×103 g/mol and 1.2×103 g/mol, most preferably 1.0×103 g/mol., most preferably a polytetrahydrofuran.
35. Process according to one of embodiments 26 to 34, wherein the chain extender (CE-A) is selected from the group consisting of 1,2-ethylene glycol, 1,2-propanediol, 1,3-propanediol, 1,4-butanediol, 2,3-butanediol, 1,5-pentanediol, 1,6-hexanediol, diethylene glycol, di-, tri-, tetra-, penta-, hexa-, hepta-, okta-, nona- and/or deca alkylene glycole dipropylene glycol, 1,4-cyclohexanediol, 1,4-dimethanol cyclohexane, neopentylglycol and hydroquinone bis(beta-hydroxyethyl) ether (HQEE), or is a mixture thereof, preferably the chain extender (CE-A) is selected from the group consisting of 1,2-ethylene gly-col, 1,3-propanediol, 1,4-butanediol, and 1,6-hexanediol, di-, tri-, tetra-, penta-, hexa-, hepta-, okta-, nona- and/or deca alkylene glycole, preferably respective oligo- and/or polypropylene glycole, or is a mixture thereof, more preferably the chain extender (CE-A) is selected from the group consisting of 1,3-propaned diol or 1,4-butane diol, or is a mixture thereof, most preferably the chain extender (CE-A) is a mixture of 1,3-propaned diol or 1,4-butane diol.
36. Process according to one of embodiments 26 to 35, wherein the Shore D hardness of com-position (B) measured according to DINISO 7619-1 (2016) is more than 30, preferably more than 40, preferably more than 55.
37. Process for producing an article using particles according to one of embodiments 1 to 12 or a granulate according to any one of embodiments 13 to 25.

The invention is further described by examples. The examples relate to practical and in some cases preferred embodiments of the invention that do not limit the scope of the invention.

### EXAMPLES

### 1. Example 1

### 1.1 Apparatus Used

Extruder 1 (composition A)
Coperion ZSK32
Extruder: co-rotating twin screw extruder (reactive)
Diameter: d=32 mm and length 56d
Temperature mixing zone 210-225 °C.
Temperature melting zone 18:182 °C.
Pressure before die: 70 bar
Extruder 2 (composition B)-non reactive, only plastification
Single screw extruder
Diameter d=20 mm and length 25D
3 Zones: T=145 °C, 180 °C, 200 °C all
Flexible hose connecting extruder 3 with die: T=220 °C.
Pressure before die; 100 bar
Gear pumps: EXTRU 4.7-1; WITTE PUMPS
Coex Die (Coaxial): 2M Tech; T=200 °C; Die diameter: 2.6 mm

### 1.2 Material:

Composition (A): starting materials used
   H12MDI (40% by weight)
   polytetrahydrofurane 1000 (51% by weight)
   1,4 butandiol (5% by weight)
   1,3 propandiol (2% by weight)
Composition (B) Thermoplastic polyurethane based on H12MDI (48% by weight), polytetrahydrofurane 1000 (40% by weight) and 1,4-butanediol (pellets)

### 1.3 Preparation

The melt of the core material of composition (A) was produced on a Coperion ZSK32 with a diameter of 32 mm and a length 56 times the diameter.
The index was adjusted to 980 to 1000 (ratio of isocyante groups to hydroxyl groups of the diol and chain extender). The chain extender was added in the fifth zone of the reaction extruder. The screw speed was adjusted to 200 U/min. The temperature profile was set between 180-220 °C. After a residence time of at least 60 seconds the melt was carried via gear pump towards the inlet of the co-extrusion die.
The melt of the shell material of composition (B) was obtained by plasticizing pellets of composition (B) via a single screw extruder from the company Labtech. The extruder had a diameter of 20 mm and a length of 25 times the diameter. The pellets consisted of composition (B) which was already synthesized in a first separate process step. To reduce the moisture content of the pellets, the material was dried 12 hours at 40° with dry air. The temperature profile of the 3 heating zones was set between 145-200 °C. The connection between the Labtech extruder and the die was realized via an electrical, heated, flexible hose of the company Winkler.
In the co-extrusion die, the melt stream of composition (A) was formed to a cylindrical strand with a diameter of 2.3 mm which was subsequently covered by tubular melt stream of composition (B). The formed core-shell structure was guided into a water bath (room temperature) for cooling and fed towards a pelletizer to obtain cylindrical granules with an open cross section area which was not completely covered by composition (A). The granule showed a clear improvement towards agglutination/blocking.

### 2. Example 2

### 2.1 Apparatus Used

Extruder 1: Mekuma; Modell ZK45/30
Extruder 2 and 3: Mekuma; Modell ZK30/30
Flat film die: FD600-3K; E.M.O. Extrusion Machinery, Die width 600 mm

### 2.2 Materials Used

Composition (A): Thermoplastic polyurethane based on H12MDI (40% by weight), polytetrahydrofurane 1000 (51% by weight) and a mixture of 1,4-butanediol/1,3-propandiol
Composition (B) Thermoplastic polyurethane based on H12MDI (48% by weight), polytetrahydrofurane 1000 (40% by weight) and 1,4-butanediol
   Granules of the core material of composition (A) and of composition (B) were obtained by reactive extrusion were produced on a Berstorff ZE 40 twin-screw extruder equipped with a perforated plate and a micro underwater pelletizer from Gala. The index was adjusted in the range of from 950 to 1050. The chain extender was added in the fifth zone or the reaction extruder. After a residence time of at least 60 seconds the melt is carried via gear pump towards the inlet of the co-extrusion die. The die temperature was between 180 and 220 °C.

### 2.3 Preparation of Particles

To obtain a TPU sheet which consist of two outer layers of composition (B) and one inner layer of composition (A) and thus forming a sandwich structure, three different melt streams are merged together in a flat sheet co-extrusion die. The two polymer melt streams of the outer layer of composition (B) were produced on two identical single screw extruders of the company Mekuma, model type ZK30/30, a diameter of 19 mm and a length of 58 cm. As feedstream, pellets of composition (B) were dosed. The five temperature zones were set between 190 and 200 °C. For the inner layer of composition (A), a Mekuma extruder model 45/30 was used for plastification. Zone temperatures of the extruder was set between 180 and 200 °C. The width of the multi-manifold sheet die was 600 mm. The die temperature was set between 185 to 200 °C. The screw speed for the extruders ZK30/30 was adapted between 5 and 15 rev/min to obtain a thickness for the outer layer between 50 and 110 μm. The screw speed of extruder type ZK45/30 was set between 50 and 90 rev/min. To cool the melt sheet, a calender unit with three tempered rollers in a horizontal arrangement. The haul-off-speed was set between 0.5 and 1m/min. Temperature of all cooling rollers was set to 15 °C. The sheet was then guided towards a granulator device which cuts the sheet in cuboids with a length of 3 mm, a width of 3 mm and a thickness of 2 mm. The cutting edge of this setup was not fully covered by composition (B).

### 3. Methods Used

### 3.1 Nanoindentation

Typ: Nano Indenter G200, Fa. KLA
Head: XP Indentation Head
Tip: Berkovich-Tip (α=) 65.27° Measurement according to ISO 14577-1.
Methode: Load Control (Load: 1 mN for composition (A) and (B), 0.3 mN for Coextrudat)

### LITERATURE CITED

US 2018/0222087 A1
US 2015/0091202
Plastics Additives Handbook, 5th Edition, H. Zweifel, ed., Hanser Publishers, Munich, 2001 ([1]), p. 98-S136
WO 94/20568
WO 2007/082838 A1
WO2017030835
WO 2013/153190 A1
WO2010010010

1. A particle, comprising:
a composition (A) comprising a thermoplastic polyurethane (PU-A); and
a composition (B) comprising a thermoplastic polyurethane (PU-B);
wherein:
the composition (A) is at least partly covered with the composition (B);
the thermoplastic polyurethane (PU-A) is a reaction product of the following building components: a diisocyanate (I-A), a diol (D-A), and optionally a chain extender (CE-A);
the thermoplastic polyurethane (PU-B) is a reaction product of the following building components: a diisocyanate (I-B), a diol (D-B), and optionally a chain extender (CE-B),
at least one of the building components of the thermoplastic polyurethane (PU-A) and at least one of building components of the thermoplastic polyurethane (PU-B) are at least partly the same;
a Shore A hardness of the composition (A) measured according to DINISO 7619-1 (2016) is less than 80; and
a Shore D hardness of the composition (B) measured according to DINISO 7619-1 (2016) is more than 30.

2. (canceled)

3. The particle according to claim 1, wherein the composition (A) is completely covered by the composition (B).

4. The particle according to claim 1, wherein:
the composition (A) is covered with a film of the composition (B); and
the film of the composition (B) has a thickness of less than 1 mm.

5. The particle according to claim 1, wherein the diisocyanate (I-A) is an aliphatic diisocyanate.

6. The particle according to claim 1, wherein the Shore A hardness of the composition (A) measured according to DINISO 7619-1 (2016) is less than 50.

7. The particle according to claim 1, wherein the diol (D-A) is a polyether diol.

8. The particle according to claim 1, wherein the chain extender (CE-A) is at least one selected from the group consisting of 1,2-ethylene glycol, 1,2-propanediol, 1,3-propanediol, 1,4-butanediol, 2,3-butanediol, 1,5-pentanediol, 1,6-hexanediol, diethylene glycol, di-, tri-, tetra-, penta-, hexa-, hepta-, okta-, nona- and/or deca alkylene glycol dipropylene glycol, 1,4-cyclohexanediol, 1,4-dimethanol cyclohexane, neopentylglycol, and hydroquinone bis(betahydroxyethyl) ether (HQEE).

9. The particle according to claim 1, wherein the Shore D hardness of the composition (B) measured according to DINISO 7619-1 (2016) is more than 55.

10. A granulate comprising the particle according to claim 1.

11. A process for producing the particle according to claim 1, comprising:
(i) extruding a skein (S-A) of the composition (A);
(ii) covering the skein (S-A) with the composition (B) to form a skein (S-AB); and
(iii) forming particles from the skein (S-AB).

12. The process according to claim 11, wherein the skein (S-A) is coextruded with a tubular skein (S-B) of the composition (B) to form the skein (S-AB).

13. The process according to claim 11, wherein the skein (S-AB) is crimped to form pellets.

14. A process for producing an article, comprising processing the particle according to claim 1.
